(19) United States
(12) Patent Application Publication
(10) Pub. No.: US 2003/0019144 A1
(43) Pub. Date: Jan. 30, 2003

(54) Crustacean attractant

(75) Inventor: Harold D. Thompson, Ellensburg, WA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Somate Corporation, Ellensburg, WA

(21) Appl. No.: 10/162,114

(22) Filed: Jun. 3, 2002

Related U.S. Application Data
(60) Provisional application No. 60/307,553, filed on Jul. 24, 2001.

(51) Int. Cl. A01K 69/00; A01K 71/00; A01K 73/00; A01K 75/00; A01K 79/00

(52) U.S. Cl. 43/4.5

(57) ABSTRACT

The present invention relates to a method of attracting a crustacean comprising generating a sound recording of a feeding crustacean. The invention also provides a device for attracting crustaceans by generating sound waves corresponding to the sounds of a feeding crustacean; a transducer for coupling the sounds to water, and a trap proximal to the transducer for entrapping attracted crustaceans.

### RELATED APPLICATION

This application claims the benefit of U.S. Provisional Application No. 60/307,553, filed Jul. 24, 2001, the entire teachings of which are incorporated herein by reference.

### BACKGROUND OF THE INVENTION

The fishing industry including the capture and sale of crabs, lobsters, shrimps, prawns and other crustaceans plays an important role in the world's food supply and global economy. Methods which improve the efficiency of current fishing methods are needed.

### SUMMARY OF THE INVENTION

The present invention relates to the use of a sound recording of a feeding crustacean to attract crustaceans. The sound recording can be from any crustacean and need not be the same type as the type of crustacean attracted. The sound recording can be in a looped format. As used herein, “looped” means the sound recording will be repeated. In a particular embodiment, the sound recording of a feeding crustacean is a recording of a feeding crab. In an alternate embodiment, the sound recording is not a crustacean.

The invention further relates to a device which attracts crustaceans by generating sound waves corresponding to sounds of a feeding crustacean. The device comprises a transducer for coupling the sounds to the water and a trap proximal to the transducer for entrapping attracted crustaceans. The device can be placed proximal to the trap in any suitable manner which will be known to one of skill in the art. In a preferred embodiment, the device will be attached to the trap via a lanyard. In an alternative embodiment, the device can be fixed to the trap.

The present invention also relates to a method of attracting crustacean predators comprising generating a sound recording of a feeding crustacean. Also, encompassed in the present invention is a device which attracts the predators of crustaceans comprising generating a sound recording of a feeding crustacean.

### DETAILED DESCRIPTION OF THE INVENTION

Traditionally, crustaceans such as crabs and lobsters and fish are attracted for food harvesting and scientific research by use of bait placed in traps. Bait emits a scent that will attract crustaceans and fish that are down current to the traps. The present invention is based, in part, on the discovery that a sound recording of a feeding crustacean can attract crustaceans. Since sound can travel in all directions simultaneously, the present invention can attract crustaceans and fish that are not down current. The present invention will have broad applications including the attraction of crustaceans and their predators for commercial harvest and scientific research.

In one embodiment, the present invention is directed to a method of attracting a crustacean comprising generating a sound recording of a feeding crustacean. “Attracting” as used herein, refers to the ability of the recorded sounds to cause, arouse or compel the target crustacean or fish to draw near. Crustaceans suitable for use in the present invention include but are not limited to crabs, shrimps, lobsters, and prawns. The sound recording of a feeding crustacean of one type (species) of crustacean can be used to attract the same type of crustacean. Alternatively, the sound recording of one type of a feeding crustacean can be used to attract a different type of crustacean.

In a preferred embodiment, the present invention is directed toward a method of attracting crabs by generating a sound recording of a feeding crab. In an alternate embodiment, the sound recording is not a crustacean. For example, the recording can be of a non-crustacean or can be artificially produced. As used herein, “artificially produced” refers to sounds that are produced by non-living things such as musical instruments.

The recording can be from about 1 second to 10 hours, preferably from about 5 to 60 seconds. The recording is preferably in a looped format. Looped formats are known to those of skill in the art and include for example, the use of a flash memory chip. A looped format enables the recording to be repeated enabling crustaceans to migrate to the repeating sound.

The invention further relates to a method for attracting a predator of a crustacean by generating a sound recording of a feeding crustacean. Predators are drawn to accumulations of prey. Since the present invention attracts crustaceans, it can attract their predators. The present invention can be useful for harvesting the predators of crustaceans. The present invention can also be used to study the interaction between crustaceans, and the interaction between crustaceans and their predators. The understanding of crustacean and crustacean/predator behavior will lead to improvements in harvesting techniques and management of resources.

The present invention also encompasses a device which attracts a crustacean by generating sound waves corresponding to the sounds of a feeding crustacean; a transducer for coupling the sounds to water and a trap proximal to the transducer for entrapping attracted crustaceans. In a preferred embodiment, the device comprises a power source, an amplifier, a transducer, and a computer chip. The device can optionally include a flash memory chip. The device can be placed in, near or be an integral part of a trap. The device can be constructed of any suitable material known at present or in the future which has desirable characteristics such as resistance to pressure, waterproofness, durability, ease of use, and ability to transmit the recorded sounds through water. Design of the device can vary according to the proposed crustacean it is meant to attract. For example, a device intended to attract King Crabs will be able to function at the depths were King Crabs are found. Other design considerations are well within one of skill in the art.

The device can be used for food harvesting or scientific research of the attracted crustaceans. Alternatively, the recording could be used for attracting crustaceans for educational purposes, such as an exhibit in an aquarium.

The invention will be further described with reference to the following non-limiting examples. The teachings of all patents, patent applications and all other publications and websites cited herein are incorporated by reference in their entirety.

Exemplification

Electronic Crustacean Caller

The Electronic Crustacean Caller produces a series of electronic vibrations by a flash memory chip. The sounds or vibrations are passed through an amplifier and emitted into the water by means of a transducer. The unit is powered by a DC battery and housed in a pressure proof and waterproof container. Vibrations are transmitted in a 360 degree radius (omnidirectional).

Sound Recording

Sound recording of King Crabs, registration number SRu 410-718, was registered with the Copyright Office on Apr. 7, 2000.

Methods

Recordings of feeding King or Dungeness crabs were made on a digital audio tape (DAT). The recordings were then played in tanks containing King crabs or Dungeness crabs. Attraction of the crabs to the recording source was monitored.

Results

King crabs and Dungeness crabs were attracted by the recorded feeding sounds of either species of crabs.

Conclusion

The Electronic Crustacean Caller speeds up the time required for crustaceans to find the bait in a commercial pot (trap). The vibrations recorded in the device duplicate the vibrations emitted by feeding crustaceans. The feeding vibrations produce a strong impulse in the crustacean to find the source of the feeding activity. The Electronic Crustacean Caller transmits the feeding vibrations in a 360 degree radius to attract the first targeted species. Once the first specimen is caught it will begin feeding on the bait in the trap and call the others.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for attracting a crustacean comprising generating a sound recording of a feeding crustacean.

2. The method of claim 1, wherein the sound recording is looped.

3. The method of claim 1, wherein the crustacean is a crab.

4. The method of claim 1, wherein the type of crustacean that is attracted is the same type as the crustacean that is recorded.

5. The method of claim 1, wherein the type of crustacean that is attracted is not the same type as the crustacean that is recorded.

6. The method of claim 1, wherein the sound recording is not a crustacean.

7. A device which attracts a crustacean by generating sound waves corresponding to the sounds of a feeding crustacean; a transducer for coupling the sounds to water, and a trap proximal to the transducer for entrapping attracted crustaceans.

8. The device of claim 7, wherein the sound recording is looped.

9. The device of claim 7, wherein the crustacean is a crab.

10. The device of claim 7, wherein the type of crustacean that is attracted is the same type as the crustacean that is recorded.

11. The device of claim 7, wherein the type of crustacean that is attracted is not the same type as the crustacean that is recorded.

12. The device of claim 7, wherein the sound recording is not a crustacean.

13. A method of attracting a predator of a crustacean comprising generating a sound recording of a feeding crustacean.

14. A device for attracting a predator of a crustacean by generating sound waves corresponding to the sounds of a feeding crustacean; a transducer for coupling the sounds to water, and a trap proximal to the transducer for entrapping attracted predators of crustaceans.
